(19) United States
(12) Patent Application Publication
(10) Pub. No.: US 2020/0345036 A1
(43) Pub. Date: Nov. 5, 2020

(54) METHOD AND COMPOSITION FOR IMPROVING HEALTH OF AN ANIMAL COMPRISING CELLS OF ORGANISM CONSISTING OF THE STRAINS WITHIN THE ORDER CLOSTRIDIALES

(71) Applicant: WHITE DOG LABS, INC., New Castle, DE (US)

(72) Inventors: Alon KARPOL, Tel-Mond (IL); Hadar GILARY, Mobile Post Hefer (IL); Shawn William JONES, Bear, DE (US); Bryan P. TRACY, Wilmington, DE (US); Biniam MARU, New Castle, DE (US); Aharon M. EYAL, Jerusalem (IL)

(73) Assignee: WHITE DOG LABS, INC., New Castle, DE (US)

(21) Appl. No.: 16/961,990

(22) PCT Filed: Jan. 4, 2019
(86) PCT No.: PCT/US2019/012332

§ 371 Date: Jul. 14, 2020

Related U.S. Application Data
(60) Provisional application No. 62/613,553, filed on Jan. 4, 2018.
(60) Provisional application No. 62/769,041, filed on Nov. 19, 2018.

(51) Int. Cl. A23K 10/18; A23K 50/75; A23L 33/135

(52) U.S. Cl. CPC A23K 10/18; A23L 33/135; A23K 50/75

(57) ABSTRACT

Methods and compositions utilizing organism consisting of the strains within the order Clostridiales for improving health of animals. Disclosed methods comprise administering an effective dose of a composition comprising organism consisting of the strains within the order Clostridiales to an animal, including for example, a broiler or hen, thereby improving said animal's health. Also disclosed are compositions including organism consisting of the strains within the order Clostridiales such as Eubacterium aggregans, acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubacterium aggregans, Eubacterium limosum, Paraclostridium bifermentans, Oxobacter pfennigii, Sporomusa termitida, and Terrisporobacter glycolicus.use in such methods.

### CROSS-REFERENCE TO RELATED APPLICATIONS

The present application claims the benefit of U.S. Provisional Application Ser. No. 62/613,553, filed Jan. 4, 2018, and U.S. Provisional Application Ser. No. 62/769,041, filed Nov. 19, 2018, the disclosures of which are expressly incorporated by reference herein in their entireties.

### FIELD OF THE INVENTION

The field of art to which this invention generally pertains is improving health of an animal and method and composition comprising cells of organism consisting of the strains within the order Clostridiales to improving health of an animal.

### BACKGROUND OF THE INVENTION

A number of documents have appeared in the literature describing the scientific basis for use of probiotics, as intestinal inoculants for animals. Since Metchnikoff work on the 19' century, who first establish the probiotic understanding as we know it, many studies have shown the ability of microorganisms to suppress pathogen growth, improve feed conversion ratio or stimulate the immune system. For example, feeding viable Lactobacillus acidophilus cells to young dairy calves was shown to reduce the incidence of diarrhea, and increase the numbers of lactobacilli and reduce coliform counts in feces.

It is generally held that during periods of low disease resistance, such as stress, undesirable microorganisms are able to proliferate in the gastrointestinal tract (G1 tract) of animals, humans included. Maintaining a normal, healthy balance of microorganisms is deemed to be critical, particularly during such stressful periods. The concept underlying use of probiotics therefore is that, if sufficient numbers of an appropriate microorganism(s) are introduced into the intestinal tract (i) at times of stress and/or disease, (ii) at birth, or (iii) after antibiotic treatment, the negative consequences of the microbial imbalances (Dysbiosis) can be minimized or overcome. Using such preparations of live, naturally occurring microorganisms helps restore and maintain the proper balance of beneficial microbes in the GI tract during times of stress, disease, and following antibiotic therapy.

Probiotics for animals are bacterial or yeast preparations that are administered orally or added to feeds. Oral administration is a relative simple process to execute, but the microorganisms must survive the passage in the stomach at low pH and to show tolerance to the bile salts in the GI tracks, until they colonize the intestinal tracks.

An alternative to oral administration is in-ovo application, in which the agent (bacteria, yeast) is injected into the egg at day 13 to 16 after laying. Obviously, this method is applicable for animals who lays eggs, mainly fowls such as chickens, turkey, duck, etc. There are several advantages associated with in-ovo application. For example, the colonization is done at an early stage of the chick, when the GI tracks are not inhibited by other bacteria, thus increasing the chance for successful and persistence colonization. Similarly, since the GI tracks are still under-developed, their pH is not very acidic and bile salts concentration is low, making the passage through the stomach in less stringent conditions. Finally, since the number of cells needed for the application is lower, the required dozes are smaller, helping to reduce the costs of the probiotics.

In today's practice of in-ovo probiotics application, the main bacteria that are being administer are genera such as Lactobacillus, Enterococcus, and Bifidobacterium. Although those genera are beneficial in some cases, they do not belong to the class of clostridia which is the early colonizers of the GI track and the most prevailing class in the broiler's gut. Furthermore, they do not produce detectable level of butyric acid, if at all, which is an essential molecule to stimulate the GI tracks against pathogens. Also, those genera are mostly strict aerobic bacteria or facultative anaerobic, which means that in the anaerobic environment of the GI track, they perform less than their optimal performances.

### SUMMARY OF THE INVENTION

According to one aspect of current invention, provided is a method of treating an animal, comprising administering to said animal an effective dose of a composition comprising at least one organism selected from the group consisting of the strains within the order Clostridiales, thereby improving said animal's health.

According to an embodiment, said organism comprises a member of a genus selected from the group consisting of Acetobacterium, Acetoanaerobium, Blautia, Butyribacterium, Clostridium, Eubacterium, Hungateiclostridium, Lachnoclostridium, Moorella, Oxobacter, Paraclostridium, Peptoclostridium, Pseudoclostridium, Ruminiclostridium, Sporomusa, Terrisporobacter, Thermoanaerobacter, Thermoanaerobacterium, and Thermoclostridium.

According to an embodiment, said organism comprises at least one of Eubacterium aggregans, acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubgacterium aggregans, Eubacterium limosum, Paraclostridium bifermentans, Oxobacter pfennigii, Sporomusa termitida, or Terrisporobacter glycolicus.

According to an embodiment, said animal is selected from the group consisting of human, pigs, cows, fish, shrimps, horses, mammals, fishes, crustacean, avians and reptiles. According to an embodiment, said animal is selected from the group consisting of broilers, hens, turkeys, ducks, and fowls.

According to an embodiment, said improving health comprises colonizing said animal's digestive track with said organism. According to an embodiment, said colonizing comprises colonizing at least one of duodenum, jejunum, ileum, small intestine, cecum, and colon.

According to an embodiment, said administering is repeated at least four times.

According to an embodiment, said composition comprises cells of said organism at a concentration of at least 10¹ Colony-Forming Units per milliliter. According to an embodiment, said administering results in at least 10 organism Colony-Forming Units per gram wet feces of said animal on the second day after administering.

According to an embodiment, said colonizing results in at least 100 Colony-Forming Units per gram wet feces of said animal on the twentieth day after administering.

According to an embodiment, said improving health comprises at least one of regulating the immune system, improving digestion, inhibiting the growth of pathogenic bacteria, forming butyric acid, reducing or preventing respiratory problems, reducing or preventing Coccidia infection, utilizing lactic acid, reducing or preventing dysbiosis, improving feed utilization, improving feed conversion, reducing or eliminating antibiotic use, decreasing mortality, and reducing deformities.

According to an embodiment, said improving health comprises forming butyric acid at a rate sufficient to reach butyric acid concentration of at least 0.1 millimolar in the digestive track. According to an embodiment, said improving health comprises forming butyric acid at a rate of at least 0.01 millimole per hour.

According to an embodiment, said administering comprises in ovo application.

According to an embodiment, said in ovo application improves hatchability rate of eggs. According to an embodiment, said in ovo application reduces the time until hatching.

According to an embodiment, said composition comprises a live vegetative culture of said organism. According to an embodiment, said composition comprises a sporulated culture of said organism.

According to an embodiment, said composition further comprises at least one of water, food, prebiotics, and probiotics.

According to an embodiment, said composition further comprises cells of at least one Bacillus amyloliquefaciens; Bacillus toyonensis; Bacillus coagulans; Bacillus licheniformis; Bacillus megaterium; Bacillus mesentricus; Bacillus polymyxa; Bacillus subtilis; Bifidobacterium animalis; Bifidobacterium bifidium; Bifidobacterium bifidus; Bifidobacterium thermophilus; Bifidobacterium longum; Bifidobacterium pseudolongum; Bifidobacterium lactis; Clostridium butyricum; Enterococcus faecium; Enterococcus faecalis; Eschericia coli; Lactobacillus thermophilus; Lactobacillus acidophilus; Lactobacillus brevis; Lactobacillus bulgaricus; Lactobacillus casei; Lactobacillus delbrueckii; Lactobacillus subspecies; Lactobacillus bulgaricus; Lactobacillus farciminis; Lactobacillus fermentum; Lactobacillus gallinarum; Lactobacillus jensenii; Lactobacillus paracasei; Lactobacillus plantarum; Lactobacillus reuteri; Lactobacillus rhamnosus; Lactobacillus lactis; Lactobacillus salivarius; Lactobacillus sobrius; Megasphaera elsdenii; Pediococcus acidolactici; Propionibacterium shermanii; Propionibacterium freudenreichii; Propionibacterium acidipropionici; Propionibacterium jensenii; Saccharomyces bourlrdii; Saccharomyces cerevisiae; Saccharomyces servisia; Streptococcus faecalis; Streptococcus faecium; Streptococcus gallolyticus; Streptococcus salivarius; Streptococcus subsp.; Streptococcus thermophilus; and Streptococcus bovis.

According to an embodiment, said composition comprises a mixture of organisms. According to an embodiment, said mixture of organisms is a syntrophic mixture showing syntrophic behavior. According to an embodiment, said syntrophic behavior is beneficial to said animal.

According to an embodiment, said mixture of organisms comprises at least one CO₂-utilizing organism. According to an embodiment, said CO₂-utilizing organism is an acetogen. According to an embodiment, said acetogen is selected from the group consisting of Acetobacterium woodii, Blautia producta, Butyribacterium methylotrophicum, Clostridium autoethanogenum, Clostridium carboxidivorans, Clostridium drakei, Clostridium ljungdahlii, Clostridium scatologenes, Eubacterium aggregans, Eubacterium limosum, Paraclostridium bifermentans, Oxobacter pfennigii, Sporomusa termitida, or Terrisporobacter glycolicus. According to an embodiment, said mixture of organisms comprises at least one non-CO₂ utilizing organism.

According to an embodiment, said mixture of organisms comprises at least one acetate-forming organism and at least one acetate-utilizing organism. According to an embodiment, said mixture of organisms comprises at least one lactate-forming organism and at least one lactate-utilizing organism.

According to an embodiment, provided is a method for preparing said composition, comprising anaerobic fermentation, optionally induction of sporulation and separation of the formed cells.

According to another aspect of current invention, provided is composition for a probiotic application, comprising at least one organism selected from the group consisting the organisms within the order Clostridiales, and a carrier. According to an embodiment, said carrier maintains an anaerobic environment for said organism. According to an embodiment, said probiotic application is an in ovo injection. According to an embodiment, said probiotic application is by Fecal Microbiota Transplantation.

According to an embodiment, said organism is characterized by at least one of butanoate metabolism, obligate anaerobic growth, gas fixation via the reductive acetyl-coenzyme A pathway, tolerance to bile salts at concentration greater than 0.05%, tolerance to pH of less than 3.5, and self-aggregation.

According to an embodiment, said organism is selected from the group consisting of Eubacterium aggregans; Eubacterium albensis; Eubacterium barkeri; Eubacterium budayi; Eubacterium callanderi; Eubacterium cellulosolvens; Eubacterium combesii; Eubacterium coprostanoligenes; Eubacterium dolichum; Eubacterium eligens; Eubacterium eligens; Eubacterium hallii; Eubacterium hallii; Eubacterium limosum; Eubacterium multiforme; Eubacterium nitritogenes; Eubacterium oxidoreducens; Eubacterium pectinii; Eubacterium plexicaudatum; Eubacterium pyruvativorans; Eubacterium ramulus; Eubacterium rangiferina; Eubacterium rectale; Eubacterium ruminantium; Eubacterium siraeum; Eubacterium thermomarinus; Eubacterium uniforme; Eubacterium ventriosum and Eubacterium xylanophilum. According to an embodiment, said organism is Eubacterium aggregans.

According to an embodiment, said organism comprises a member of a genus selected from the group consisting of Acetobacterium, Acetoanaerobium, Blautia, Butyribacterium, Clostridium, Desulfitobacterium, Desulgotomaculum, Eubacterium, Hungateiclostridium, Lachnoclostridium, Moorella, Oxobacter, Paraclostridium Peptoclostridium, Pseudoclostridium, Ruminiclostridium, Sporomua, Terrisporobacter, Thermoanaerobacter, Thermoanaerobacterium, and Thermoclostridium.

According to an embodiment, said organism comprises at least one of Acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubacterium aggregans, Eubacterium limosum, Paraclostridium bifermentans, Oxobacter pfennigii, Sporomusa termitida, or Terrisporobacter glycolicus.

According to an embodiment, said carrier is selected from the group consisting of aqueous solution of salts and/or of sugars.

According to another aspect of current invention, provided is a method of treating an avian comprising administering in ovo an effective dose of a composition comprising an organism selected from the group consisting of the organisms within the order Clostridiales, thereby improving its health.

According to an embodiment, said organism is characterized by at least one of butanoate metabolism, obligate anaerobic growth, gas fixation via the reductive acetyl-coenzyme A pathway, tolerance to bile salts at concentration greater than 0.05%, tolerance to pH of less than 3.5, and self-aggregation.

According to an embodiment, said organism is selected from the group consisting of Eubacterium aggregans; Eubacterium albensis; Eubacterium barkeri; Eubacterium budayi; Eubacterium callanderi; Eubacterium cellulosolvens; Eubacterium combesii; Eubacterium coprostanoligenes; Eubacterium dolichum; Eubacterium eligens; Eubacterium eligens; Eubacterium hallii; Eubacterium hallii; Eubacterium limosum; Eubacterium multiforme; Eubacterium nitritogenes; Eubacterium oxidoreducens; Eubacterium pectinii; Eubacterium plexicaudatum; Eubacterium pyruvativorans; Eubacterium ramulus; Eubacterium rangiferina; Eubacterium rectale; Eubacterium ruminantium; Eubacterium siraeum; Eubacterium thermomarinus; Eubacterium uniforme; Eubacterium ventriosum; and Eubacterium xylanophilum. According to an embodiment, said organism is Eubacterium aggregans.

According to an embodiment, said organism comprises a member of a genus selected from the group consisting of Acetobacterium, Acetoanaerobium, Blautia, Butyribacterium, Clostridium, Desulfitobacterium, Desulgotomaculum, Eubacterium, Hungateiclostridium, Lachnoclostridium, Moorella, Oxobacter, Paraclostridium Peptoclostridium, Pseudoclostridium, Ruminiclostridium, Sporomua, Terrisporobacter, Thermoanaerobacter, Thermoanaerobacterium, and Thermoclostridium.

According to an embodiment, said organism comprises at least one of Acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubacterium aggregans, Eubacterium limosum, Paraclostridium bifermentans, Oxobacter pfennigii, Sporomusa termitida, or Terrisporobacter glycolicus.

According to an embodiment, said avian is selected from the group consisting of broilers, hens, turkeys, ducks, and fowls.

According to an embodiment, said improving health comprises colonizing said avian's digestive track with said organism. According to an embodiment, said improving health comprises colonizing the embryo digestive track with said organism. According to an embodiment, said colonizing comprises colonizing at least one of duodenum, jejunum, ileum, small intestine, cecum, and colon.

According to an embodiment, said improving health comprises at least one of regulating the immune system, improving digestion, inhibiting the growth of pathogenic bacteria, forming butyric acid, reducing or preventing respiratory problems, reducing or preventing Coccidia infection, utilizing lactic acid, reducing or preventing dysbiosis, improving feed utilization, improving feed conversion, reducing or eliminating antibiotic use, decreasing mortality, and reducing deformities.

According to an embodiment, said improving health comprises forming butyric acid at a rate sufficient to reach butyric acid concentration of at least 0.1 millimolar in the digestive track. According to an embodiment, said improving health comprises forming butyric acid at a rate of at least 0.01 millimole per hour.

According to an embodiment, said composition comprises a live culture of said organism. According to an embodiment, said composition comprises a sporulated culture of said organism.

According to an embodiment, said composition further comprises at least one of water, food, prebiotics and probiotics.

According to an embodiment, said composition further comprises cells of at least one Bacillus amyloliquefaciens; BacillusBacillus toyonensis; BacillusBacillus coagulans; BacillusBacillus licheniformis; Bacillus megaterium; Bacillus mesentricus; Bacillus polymyxa; Bacillus subtilis; Bifidobacterium animalis; Bifidobacterium bifidium; Bifidobacterium bifidus; Bifidobacterium thermophilus; Bifidobacterium longum; Bifidobacterium pseudo longum; Bifidobacterium lactis; Clostridium butyricum; Enterococcus faecium; Enterococcus faecalis; Eschericia coli; Lactobacillus thermophilus; Lactobacillus acidophilus; Lactobacillus brevis; Lactobacillus bulgaricus; Lactobacillus casei; Lactobacillus delbrueckii; Lactobacillus subspecies; Lactobacillus bulgaricus; Lactobacillus farciminis; Lactobacillus fermentum; Lactobacillus gallinarum; Lactobacillus jensenii; Lactobacillus paracasei; Lactobacillus plantarum; Lactobacillus reuteri; Lactobacillus rhamnosus; Lactobacillus lactis; Lactobacillus salivarius; Lactobacillus sobrius; Megasphaera elsdenii; Pediococcus acidolactici; Propionibacterium shermanii; Propionibacterium freudenreichii; Propionibacterium acidipropionici; Propionibacterium jensenii; Saccharomyces bourlrdii; Saccharomyces cerevisiae; Saccharomyces servisia; Streptococcus faecalis; Streptococcus faecium; Streptococcus gallolyticus; Streptococcus salivarius; Streptococcus subsp.; Streptococcus thermophilus; and Streptococcus bovis.

According to an embodiment, said composition comprises a mixture of organisms. According to an embodiment, said mixture of organisms is a syntrophic mixture showing a syntrophic behavior. According to an embodiment, said syntrophic behavior is beneficial to said animal. According to an embodiment, said mixture of organisms comprises at least one CO₂-utilizing organism. According to an embodiment, said CO₂-utilizing organism is an acetogen. According to an embodiment, said acetogen is selected from the group consisting of Acetobacterium woodii, Blautia producta, Butyribacterium methylotrophicum, Clostridium autoethanogenum, Clostridium carboxidivorans, Clostridium drakei, Clostridium ljungdahlii, Clostridium scatologenes, Eubacterium aggregans, Eubacterium limosum, Oxobacter pfennigii, Sporomusa termitida, and Terrisporobacter glycolicus. According to an embodiment, said mixture of organisms comprises at least one non-CO₂ utilizing organism. According to an embodiment, said mixture of organisms comprises at least one acetate-forming organism and at least one acetate-utilizing organism. According to an embodiment, said mixture of organisms comprises at least one lactate-forming organism and at least one lactate-utilizing organism.

According to an embodiment, said in ovo administering improves hatchability of eggs.

According to an embodiment, said in ovo administering reduces the time until hatching.

### BRIEF DESCRIPTION OF THE DRAWINGS

FIG. 1 shows hatchability results of IOF with Libraries A1 and D1.

FIG. 2 shows late hatching with Library A1.

FIG. 3 shows late hatching with Library D1.

### DETAILED DESCRIPTION OF THE INVENTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

As used herein, the term in-ovo application refers to the insertion of live virus or live bacteria into avian eggs embryos.

As used herein, the term Tolerance to pH refers to survival of at least 1% of the cells exposed to the condition for duration of 2 hours.

As used herein, the term Tolerance to Oxgal refers to survival of at least 10% of the cells exposed to the condition for duration of 24 hours.

According to one aspect of current invention, provided is a method of treating an animal, comprising administering to said animal an effective dose of a composition comprising at least one organism selected from the group consisting of the strains within the order Clostridiales, thereby improving said animal's health

According to an embodiment, said organism comprises a member of a genus selected from the group consisting of Acetobacterium, Acetoanaerobium, Blautia, Butyribacterium, Clostridium, Eubacterium, Hungateiclostridium, Lachnoclostridium, Moorella, Oxobacter, Paraclostridium, Peptoclostridium, Pseudoclostridium, Ruminiclostridium, Sporomusa, Terrisporobacter, Thermoanaerobacter, Thermoanaerobacterium, and Thermoclostridium.

According to an embodiment, said organism comprises at least one of Eubacterium aggregans, acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubgacterium aggregans, Eubacterium limosum, Paraclostridium bifermentans, Oxobacter pfennigii, Sporomusa termitida, or Terrisporobacter glycolicus.

According to an embodiment, said animal is selected from the group consisting of human, pigs, cows, fish, shrimps, horses, mammals, fishes, crustacean, avians and reptiles. According to an embodiment, said animal is selected from the group consisting of broilers, hens, turkeys, ducks, and fowls. According to an embodiment, said improving health comprises colonizing said animal's digestive track with said organism. According to an embodiment, said colonizing comprises colonizing at least one of duodenum, jejunum, ileum, small intestine, cecum and colon.

According to an embodiment the administering is conducted once, according to an embodiment the administering is divided into multiple doses, according to some embodiments the administering is given in at least one dose, at least two doses, at least three doses or at least four doses.

According to an embodiment, the whole dose, or at least a fraction, is administered on the day of hatching, day of being born or during incubation. According to other embodiments, administering the whole dose, or at least a fraction of it is conducted on the second, third, fourth, fifth, six, seven day of life.

According to an embodiment the composition comprises cells of said organism at a concentration of at least 10 Colony-Forming Units (CFU) per milliliter (ml), at least 20, at least 30, at least 40, at least 50, or at least 60 CFU per ml. According to an embodiment the composition comprises cells of said organism at a concentration 10² at least 10³, at least 10⁴, at least 10⁵, at least 10⁶ CFU per ml.

According to an embodiment the administering results in at least 100 CFU per gram wet feces of the animal on the second day after administering, at least 1,000 CFU per gram, at least 10,000 CFU per gram or at least 100,000 CFU per gram. According to an embodiment the colonizing results in at least at least 100 CFU per gram wet feces of the animal on the twentieth day after administering, at least 1,000 CFU per gram, at least 10,000 CFU per gram or at least 100,000 CFU per gram.

According to an embodiment the improving health comprises at least one of regulating the immune system, improving digestion, inhibiting the growth of pathogenic bacteria, forming butyric acid, reducing or preventing respiratory problems, reducing or preventing Coccidia infection, utilizing lactic acid, reducing or preventing dysbiosis, improving feed utilization, improving feed conversion, reducing or eliminating antibiotic use, decreasing mortality, and reducing deformities.

According to an embodiment the improving health comprises forming butyric acid at a rate sufficient to reach in the digestive track butyric acid concentration of at least 0.1 millimolar (mM), at least 0.5 mM, at least 1.0 mM or at least 2 mM.

According to an embodiment, the improving health comprises forming butyric acid at a rate of at least 0.005 millimole per hour, at least 0.01, at least 0.05 or at least 0.1 millimole per hour.

According to an embodiment the wherein administering comprises in ovo application. According to an embodiment, said in ovo application improves hatchability rate of eggs. According to an embodiment, said in ovo application reduces the time until hatching

According to an embodiment, said composition comprises a live vegetative culture of said organism. According to an embodiment, said composition comprises a sporulated culture of said organism

According to an embodiment the composition further comprises at least one of water, food, prebiotics, probiotics.

According to an embodiment the composition further comprises cells of at least one of Bacillus amyloliquefaciens; Bacillus toyonensis; Bacillus coagulans; Bacillus licheniformis; Bacillus megaterium; Bacillus mesentricus; Bacillus polymyxa; Bacillus subtilis; Bifidobacterium animalis; Bifidobacterium bifidium; Bifidobacterium bifidus; Bifidobacterium thermophilus; Bifidobacterium longum; Bifidobacterium pseudolongum; Bifidobacterium lactis; Clostridium butyricum; Enterococcus faecium; Enterococcus faecalis; Eschericia coli; Lactobacillus thermophilus; Lactobacillus acidophilus; Lactobacillus brevis; Lactobacillus bulgaricus; Lactobacillus casei; Lactobacillus delbrueckii; Lactobacillus subspecies; Lactobacillus bulgaricus; Lactobacillus farciminis; Lactobacillus fermentum; Lactobacillus gallinarum; Lactobacillus jensenii; Lactobacillus paracasei; Lactobacillus plantarum; Lactobacillus reuteri; Lactobacillus rhamnosus; Lactobacillus lactis; Lactobacillus salivarius; Lactobacillus sobrius; Megasphaera elsdenii; Pediococcus acidolactici; Propionibacterium shermanii; Propionibacterium freudenreichii; Propionibacterium acidipropionici; Propionibacterium jensenii; Saccharomyces bourlrdii; Saccharomyces cerevisiae; Saccharomyces servisia; Streptococcus faecalis; Streptococcus faecium; Streptococcus gallolyticus; Streptococcus salivarius; Streptococcus subsp.; Streptococcus thermophilus; and Streptococcus bovis.

According to an embodiment, said composition comprises a mixture of organisms. According to an embodiment, said mixture of organisms is a syntrophic mixture showing syntrophic behavior. According to an embodiment, said syntrophic behavior is beneficial to said animal.

According to an embodiment, said mixture of organisms comprises at least one CO₂-utilizing organism. According to an embodiment, said CO₂-utilizing organism is an acetogen. According to an embodiment, said acetogen is selected from the group consisting of Acetobacterium woodii, Blautia producta, Butyribacterium methylotrophicum, Clostridium autoethanogenum, Clostridium carboxidivorans, Clostridium drakei, Clostridium ljungdahlii, Clostridium scatologenes, Eubacterium aggregans, Eubacterium limosum, Paraclostridium bifermentans, Oxobacter pfennigii, Sporomusa termitida, or Terrisporobacter glycolicus. According to an embodiment, said mixture of organisms comprises at least one non-CO₂ utilizing organism.

According to an embodiment, said mixture of organisms comprises at least one acetate-forming organism and at least one acetate-utilizing organism. According to an embodiment, said mixture of organisms comprises at least one lactate-forming organism and at least one lactate-utilizing organism.

According to an embodiment the prebiotics further comprises at least trans-galactooligosaccharide, inulin, resistance starch, pectin, beta glucans.

According to one aspect of the current invention, provided is a method for preparing the composition, which method comprises anaerobic fermentation, induction of sporulation and separation of the formed cells. According to an embodiment the method for induction of sporulation comprises cultivating at phosphate concentration of less than 5%, less than 3% or less than 1%. According to an embodiment, the induction of sporulation comprises cultivating at nitrogen concentration of less than 1 mM, less than 0.1 mM or less than 0.01 mM. According to an embodiment, the induction of sporulation comprises cultivating at a temperature greater than 37 degree C., greater than 55 degree C. or greater than 75 degree C. According to an embodiment, the induction of sporulation comprises cultivating at a temperature of less than 37 degree C., less than 25 degree C. or less than 10 degree C. According to an embodiment, the induction of sporulation comprises reducing or preventing respiratory problems, reducing or preventing Coccidia infection in a medium comprising at least 100 mM solvent, at least 10 mM or at least 1 mM. According to an embodiment the method for induction of sporulation comprises cultivating at carbon concentration of less than 10 mM, less than 1 mM or less than 0.1 mM. According to an embodiment the method for induction of sporulation comprises cultivating at pH of less than 6.0, less than 5.0 or less than 4.0. According to an embodiment the method for induction of sporulation comprises cultivating at pH of more than 8.0, more than 9.0 or more than 10.0.

According to an embodiment, the separating of cells, comprises at least one of flocculating, centrifugating and separating by large scale flow cytometry, to separate the vegetative cells from the spores.

According to another aspect of current invention, provided is composition for a probiotic application, comprising at least one organism selected from the group consisting the organisms within the order Clostridiales, and a carrier. According to an embodiment, said carrier maintains an anaerobic environment for said organism. According to an embodiment, said probiotic application is an in ovo injection. According to an embodiment, said probiotic application is by Fecal Microbiota Transplantation.

According to an embodiment, said organism is characterized by at least one of butanoate metabolism, obligate anaerobic growth, gas fixation via the reductive acetyl-coenzyme A pathway, tolerance to bile salts at concentration greater than 0.05%, greater than 0.1% greater than 0.2% or greater than 0.4% tolerance to pH of less than 5.5, less than 4.5 less than 3.5 or less than 2.5 and self-aggregation.

According to an embodiment, said organism is selected from the group consisting of Eubacterium aggregans; Eubacterium albensis; Eubacterium barkeri; Eubacterium budayi; Eubacterium callanderi; Eubacterium cellulosolvens; Eubacterium combesii; Eubacterium coprostanoligenes; Eubacterium dolichum; Eubacterium eligens; Eubacterium eligens; Eubacterium hallii; Eubacterium hallii; Eubacterium limosum; Eubacterium multiforme; Eubacterium nitritogenes; Eubacterium oxidoreducens; Eubacterium pectinii; Eubacterium plexicaudatum; Eubacterium pyruvativorans; Eubacterium ramulus; Eubacterium rangiferina; Eubacterium rectale; Eubacterium ruminantium; Eubacterium siraeum; Eubacterium thermomarinus; Eubacterium uniforme; Eubacterium ventriosum and Eubacterium xylanophilum. According to an embodiment, said organism is Eubacterium aggregans.

According to an embodiment, said organism comprises a member of a genus selected from the group consisting of Acetobacterium, Acetoanaerobium, Blautia, Butyribacterium, Clostridium, Desulfitobacterium, Desulgotomaculum, Eubacterium, Hungateiclostridium, Lachnoclostridium, Moorella, Oxobacter, Paraclostridium Peptoclostridium, Pseudoclostridium, Ruminiclostridium, Sporomua, Terrisporobacter, Thermoanaerobacter, Thermoanaerobacterium, and Thermoclostridium.

According to an embodiment, said organism comprises at least one of Acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubacterium aggregans, Eubacterium limosum, Paraclostridium bifermentans, Oxobacter pfennigii, Sporomusa termitida, or Terrisporobacter glycolicus.

According to an embodiment the carrier is selected from the group consisting of aqueous solution of salts and/or of sugars. According to an embodiment the sugars are selected from the group consisting of mannitol, lactose, cellulose, glucose, sucrose, starch, amylose, fructose, and fructose oligo saccharides (FOS). According to an embodiment the salts are selected from the group consisting of NaCl, CaCl2, MgCl2, and tris(hydroxymethyl)aminomethane. According to an embodiment the concentration of the salt ranges from 0.05% to 0.5% of the solution. According to an embodiment the concentration of the sugar ranges from 2% to 10% of the solution. According to an embodiment the carriers are selected from a group consisting of antimicrobials, antioxidants, chelating agents, inert gases, organic acids, glycol, polyethylene glycol, vegetable oils, ethyl oleate. According to an embodiment the carriers are phosphate buffer solution or glycerol solution.

According to one aspect of the current invention, provided is a method of treating an avian comprising administering in ovo an effective dose of a composition comprising an organism selected from the group consisting of the organisms within the order Clostridiales, thereby improving its health.

According to an embodiment said organism is characterized by at least one of butanoate metabolism, obligate anaerobic growth, gas fixation via the reductive acetyl-coenzyme A pathway, tolerance to bile salts at concentration greater than 0.05%, greater than 0.1% greater than 0.2% or greater than 0.4%, tolerance to pH of less than 5.5, less than 4.5 less than 3.5 or less than 2.5 and self-aggregation.

According to an embodiment, said organism is selected from the group consisting of Eubacterium aggregans; Eubacterium albensis; Eubacterium barkeri; Eubacterium budayi; Eubacterium callanderi; Eubacterium cellulosolvens; Eubacterium combesii; Eubacterium coprostanoligenes; Eubacterium dolichum; Eubacterium eligens; Eubacterium eligens; Eubacterium hallii; Eubacterium hallii; Eubacterium limosum; Eubacterium multiforme; Eubacterium nitritogenes; Eubacterium oxidoreducens; Eubacterium pectinii; Eubacterium plexicaudatum; Eubacterium pyruvativorans; Eubacterium ramulus; Eubacterium rangiferina; Eubacterium rectale; Eubacterium ruminantium; Eubacterium siraeum; Eubacterium thermomarinus; Eubacterium uniforme; Eubacterium ventriosum; and Eubacterium xylanophilum. According to an embodiment, said organism is Eubacterium aggregans.

According to an embodiment, said organism comprises a member of a genus selected from the group consisting of Acetobacterium, Acetoanaerobium, Blautia, Butyribacterium, Clostridium, Desulfitobacterium, Desulgotomaculum, Eubacterium, Hungateiclostridium, Lachnoclostridium, Moorella, Oxobacter, Paraclostridium Peptoclostridium, Pseudoclostridium, Ruminiclostridium, Sporomua, Terrisporobacter, Thermoanaerobacter, Thermoanaerobacterium, and Thermoclostridium.

According to an embodiment, said organism comprises at least one of Acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubacterium aggregans, Eubacterium limosum, Paraclostridium bifermentans, Oxobacter pfennigii, Sporomusa termitida, or Terrisporobacter glycolicus.

According to an embodiment the avian is selected from the group consisting of broilers, hens, turkeys, ducks, and fowls.

According to an embodiment, said improving health comprises colonizing said avian's digestive track with said organism. According to an embodiment, said improving health comprises colonizing the embryo digestive track with said organism. According to an embodiment, said colonizing comprises colonizing at least one of duodenum, jejunum, ileum, small intestine, cecum, and colon.

According to an embodiment, said improving health comprises at least one of regulating the immune system, improving digestion, inhibiting the growth of pathogenic bacteria, forming butyric acid, reducing or preventing respiratory problems, reducing or preventing Coccidia infection, utilizing lactic acid, reducing or preventing dysbiosis, improving feed utilization, improving feed conversion, reducing or eliminating antibiotic use, decreasing mortality, and reducing deformities.

According to an embodiment the improving health comprises forming butyric acid at a rate sufficient to reach in the digestive track butyric acid concentration of at least 0.1 mM, at least 0.5 mM, at least 1.0 mM or at least 2 mM.

According to an embodiment the improving health comprises forming butyric acid at a rate of at least 0.005 millimole per hour, at least 0.01 millimole per hour, at least 0.05 millimole per hour, at least 0.1 millimole per hour.

According to an embodiment, said composition comprises a live culture of said organism. According to an embodiment, said composition comprises a sporulated culture of said organism.

According to an embodiment the composition further comprises at least one of water, food, prebiotics, and probiotics.

According to an embodiment, said composition further comprises cells of at least one Bacillus amyloliquefaciens; BacillusBacillus toyonensis; BacillusBacillus coagulans; BacillusBacillus licheniformis; Bacillus megaterium; Bacillus mesentricus; Bacillus polymyxa; Bacillus subtilis; Bifidobacterium animalis; Bifidobacterium bifidium; Bifidobacterium bifidus; Bifidobacterium thermophilus; Bifidobacterium longum; Bifidobacterium pseudo longum; Bifidobacterium lactis; Clostridium butyricum; Enterococcus faecium; Enterococcus faecalis; Eschericia coli; Lactobacillus thermophilus; Lactobacillus acidophilus; Lactobacillus brevis; Lactobacillus bulgaricus; Lactobacillus casei; Lactobacillus delbrueckii; Lactobacillus subspecies; Lactobacillus bulgaricus; Lactobacillus farciminis; Lactobacillus fermentum; Lactobacillus gallinarum; Lactobacillus jensenii; Lactobacillus paracasei; Lactobacillus plantarum; Lactobacillus reuteri; Lactobacillus rhamnosus; Lactobacillus lactis; Lactobacillus salivarius; Lactobacillus sobrius; Megasphaera elsdenii; Pediococcus acidolactici; Propionibacterium shermanii; Propionibacterium freudenreichii; Propionibacterium acidipropionici; Propionibacterium jensenii; Saccharomyces bourlrdii; Saccharomyces cerevisiae; Saccharomyces servisia; Streptococcus faecalis; Streptococcus faecium; Streptococcus gallolyticus; Streptococcus salivarius; Streptococcus subsp.; Streptococcus thermophilus; and Streptococcus bovis.

According to an embodiment, said composition comprises a mixture of organisms. According to an embodiment, said mixture of organisms is a syntrophic mixture showing a syntrophic behavior. According to an embodiment, said syntrophic behavior is beneficial to said animal. According to an embodiment, said mixture of organisms comprises at least one CO₂-utilizing organism. According to an embodiment, said CO₂-utilizing organism is an acetogen. According to an embodiment, said acetogen is selected from the group consisting of Acetobacterium woodii, Blautia producta, Butyribacterium methylotrophicum, Clostridium autoethanogenum, Clostridium carboxidivorans, Clostridium drakei, Clostridium ljungdahlii, Clostridium scatologenes, Eubacterium aggregans, Eubacterium limosum, Oxobacter pfennigii, Sporomusa termitida, and Terrisporobacter glycolicus. According to an embodiment, said mixture of organisms comprises at least one non-CO₂ utilizing organism. According to an embodiment, said mixture of organisms comprises at least one acetate-forming organism and at least one acetate-utilizing organism. According to an embodiment, said mixture of organisms comprises at least one lactate-forming organism and at least one lactate-utilizing organism.

According to an embodiment, said in ovo administering improves hatchability of eggs.

According to an embodiment, said in ovo administering reduces the time until hatching.

### EXAMPLES

### Example 1—Tolerance of E. aggregans to Acidic Conditions and to Bile Salts

According to a protocol detailed below, E. aggregans was put into contact in anaerobic conditions for 48 hours with Reinforced Clostridium Media (RCM) solutions containing bile salts (Oxgal) at various concentrations. Tolerance was 45% survival at 0.2% Oxgal concentration and 20% survival between 0.5% to 2.0% Oxgal concentrations.

Similarly, E. aggregans was put into contact in anaerobic conditions for 2 hours with RCM solutions of acidic pH. There was 77% survival at pH 4.5. These results demonstrate the tolerance in anaerobic conditions of E. aggregans to acidic pH and to a relatively high concentration of bile salts.

Protocol: Pick a single bacterial colony into 10-ml Reinforced Clostridium Media (RCM) medium, under anaerobic conditions, to serve as the inoculum. Cultivate the bacteria over night at 37 degree C. Prepare RCM solutions of desired pH and desired bile salts (Oxgal) concentration. Filter-sterilize the medium into 10-ml tubes (8-ml medium in each tube). Deoxygenate the medium in the anaerobic chamber overnight. Inoculate the 10-ml tubes with 80 microliter of inoculum culture. Incubate the medium with the cells at 37C° for 2 hours or for 48 hours (for low pH and bile acid tolerance experiences, respectively). Dilute (by a factor of ×100) the bacterial cells in RCM. Plate the cells on RCM agar plates. Cultivate the cells on the plates for 48 hours at 37 degree C. Count Colony Forming Units (CFU). Determine survival rate by dividing the number of cells on the plates by the number of cells that were challenged at pH 6.8 or no bile salts (for low pH and bile acid tolerance experiences, respectively).

### Example 2—Bacterial aggregation of E. aggregans

Aggregation characteristic for E. aggregans was measured according to the protocol detailed below. The results show that after 5 hours more than 85% of the cells have aggregated. This result confirms the ability of E. aggregans to aggregate quickly. As such during the passage of the cells through the GI tracks, the cells have a better chance to adhere to the epithelial cells of the animal and colonize them.

Protocol: Inoculate a single colony of E. aggregans in 10-ml of RCM medium. Grow the cells in an anaerobic chamber at 37 C. for 1-2 days. When the cells reach stationary growth phase, centrifuge the cells at 3000 rpm for 5 minutes. Remove the supernatant and re-suspend the pellet with 10-ml PBS. From that preparation, move 4 ml of medium and bacteria medium and adjust to Absorbance Unit (AU) of 1 using PBS. Re-suspend with vortex and sample 1 ml into spectrophotometer reading. Take 1 ml sample for AU reading at 620 nanometers from the bottom of the vial. Percent aggregation capacity (% AC) value is calculated by % AC=(1−(OD_{tf}/ODₜ₀)/100, where OD_{tf} and ODₜ₀ are the optical density at final and initial times, respectively.

### Example 3—Butyrate Production by E. aggregans

The ability of E. aggregans, in conditions mimicking the environment of the GI tracks, to produce butyric acid and to consume lactic acid was measured according to the protocol detailed below. The result showed that 94% of the lactic acid was consumed after 4 days and that butyric acid concentration reached 64 mM.

These results confirm the viability of E. aggregans at conditions that are expected to be encountered in the GI tracks of the animal or human to produce butyric acid, a known chemical that helps the immune system of the animal to fight pathogens. One of the carbon source for butyric acid production is the prevailing molecule of lactic acid in the GI tracks. Accordingly, the lactic acid was consumed almost completely by the cells of E. aggregans.

Protocol: A mid-log culture of E. aggregans was inoculated into 50-ml RCM medium, supplemented with 50 mM of lactic acid. The fermentation took place in serum bottles at 37 C without shaking. The RCM medium contains 0.5% glucose, 0.22% acetic acid. Samples were removed after 24 hours and 96 hours for HPLC analysis.

### Example 4—Improved Hatchability with In Ovo Injection

Injections directly into the developing egg, called in ovo feeding (IOF), have been shown to improve hatchability and the health of the resulting chick. Current IOF treatments primarily involve vaccines or growth substrates. IOF of probiotics could also help improve hatchability of eggs and chick health. Here, we assess the effect of IOF of two bacterial libraries on hatchability of broiler eggs.

Generating bacterial libraries: Two bacterial libraries were prepared and injected into broiler eggs. The first library contained only acetogenic strains, specifically Blautia producta DSM-2950, Butyribacterium methylotrophicum DSM-3468, and Eubacterium aggregans DSM-12183. The second library contained the same acetogenic strains along with Clostridium pasteurianum DSM-525, C. tyrobutyricum DSM-1460, and C. tyrobutyricum A7 (a novel isolate from chicken litter). The strains were grown individually on appropriate growth media. The acetogenic strains were harvested at late exponential phase (A₆₀₀ 2-5) and washed in 0.9% saline solution. The clostridial strains were harvested and washed at late exponential phase (A₆₀₀ 26-28) and again after 3 days for spores. Cell concentrates were created for each individual strain from the washed cells in 0.9% saline solution. The cell densities for each strain are listed in Table 1.

TABLE 1
Densities of cell concentrates.

| | Cell density (CFU/mL) | |
|---|---|---|
| Cell concentrate | Viable cells | Spores |
| B. producta | 1.15 × 10⁹ | — |
| (late exponential) | | |
| B. methylotrophicum | 3.80 × 10⁹ | — |
| (late exponential) | | |
| C. pasteurianum | 7.83 × 10⁸ | 4.73 × 10⁴ |
| (late exponential) | | |
| C. pasteurianum | 1.01 × 10⁷ | 1.47 × 10⁵ |
| (late stationary) | | |
| C. tyrobutyricum | 2.20 × 10⁸ | 1.75 × 10⁵ |
| (late exponential) | | |
| C. tyrobutyricum | 4.97 × 10⁵ | 1.69 × 10⁵ |
| (late stationary) | | |
| C. tyrobutyricum A7 | 1.36 × 10⁹ | 4.50 × 10⁵ |
| (late exponential) | | |
| C. tyrobutyricum A7 | 1.45 × 10⁶ | 1.14 × 10⁶ |
| (late stationary) | | |
| E. aggregans | 3.17 × 10⁶ | — |
| (late exponential) | | |

The acetogenic library (A1) was created by mixing the cell concentrates of B. producta, B. methylotrophicum, and E. aggregans to achieve an overall viable cell count of at least 1.0×10⁹ CFU/mL. The mixed library (D1) was created by mixing all the cell concentrates to achieve an overall viable cell count of at least 1.0×10⁹ CFU/mL and a spore count of at least 1.0×10⁵ CFU/mL. The libraries were then diluted to 10⁷, 10⁵, 10³, and 10¹ viable CFU/mL with 0.9% saline. All libraries were kept anaerobic in sealed serum bottles with a headspace of 10% CO₂, 5% H₂ and the balance N₂ and stored at 4° C.

In ovo injections: Broiler eggs were placed in an incubator under optimum temperature and humidity control for embryonic development. After 17 days of incubation, embryo viability was confirmed by candling, and clear eggs (i.e., infertile or early dead embryos) were removed prior to the IOF procedure. Fertile eggs were injected with 100 μL of A1 or D1 libraries at different cell concentrations or a 0.9% saline solution. Injections were made into the amniotic fluid surrounding the embryo and confirmed by iodine staining.

After injections, eggs were resealed and placed back in the incubator for another 4 days. Hatched and unhatched eggs were then counted. Unhatched eggs were classified as infertile, death before injection (i.e., before day 17), death after injection, or pipped (i.e., chick broke outer shell but was unable to fully hatch).

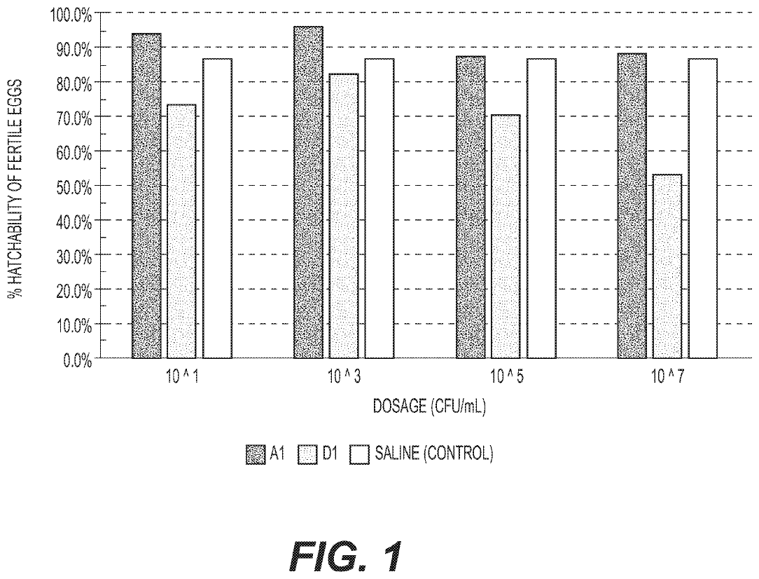

Hatch results: Hatchability was calculated as total number of hatched eggs divided by the total number of fertile eggs. Fertile eggs were calculated from the total number of eggs minus infertile eggs and embryos that died before injection. FIG. 1 and Tables 2 and 3 summarize the hatchability results.

TABLE 2
Summary of hatchability results.

| | Dose | # of | Total | Total | Total | |
|---|---|---|---|---|---|---|
| Treatment | (CFU/mL) | Eggs | Hatched | Unhatched | Fertile eggs | Hatchability |
| A1 Library | 10¹ | 87 | 79 | 8 | 84 | 94.0% |
| | 10³ | 87 | 81 | 6 | 84 | 96.4% |
| | 10⁵ | 79 | 68 | 11 | 78 | 87.2% |
| | 10⁷ | 79 | 68 | 11 | 77 | 88.3% |
| D1 Library | 10¹ | 87 | 62 | 25 | 84 | 73.8% |
| | 10³ | 87 | 70 | 17 | 85 | 82.4% |
| | 10⁵ | 79 | 56 | 23 | 79 | 70.9% |
| | 10⁷ | 82 | 44 | 38 | 82 | 53.7% |
| Saline | 0.9% | 87 | 77 | 10 | 86 | 89.5% |
| | 0.9% | 79 | 66 | 13 | 78 | 84.6% |

TABLE 3
Summary of unhatched eggs.

| | Dose | Total | | Death before | Death after | |
|---|---|---|---|---|---|---|
| Treatment | (CFU/mL) | Unhatched | Infertile | injection | injection | Pipped |
| A1 Library | 10¹ | 8 | 1 | 2 | 4 | 1 |
| | 10³ | 6 | 3 | 0 | 2 | 1 |
| | 10⁵ | 11 | 1 | 0 | 4 | 6 |
| | 10⁷ | 11 | 2 | 0 | 6 | 3 |
| D1 Library | 10¹ | 25 | 1 | 2 | 6 | 16 |
| | 10³ | 17 | 0 | 2 | 4 | 11 |
| | 10⁵ | 23 | 0 | 0 | 2 | 21 |
| | 10⁷ | 38 | 0 | 0 | 16 | 22 |
| Saline | 0.9% | 10 | 1 | 0 | 1 | 8 |
| | 0.9% | 13 | 1 | 0 | 5 | 7 |

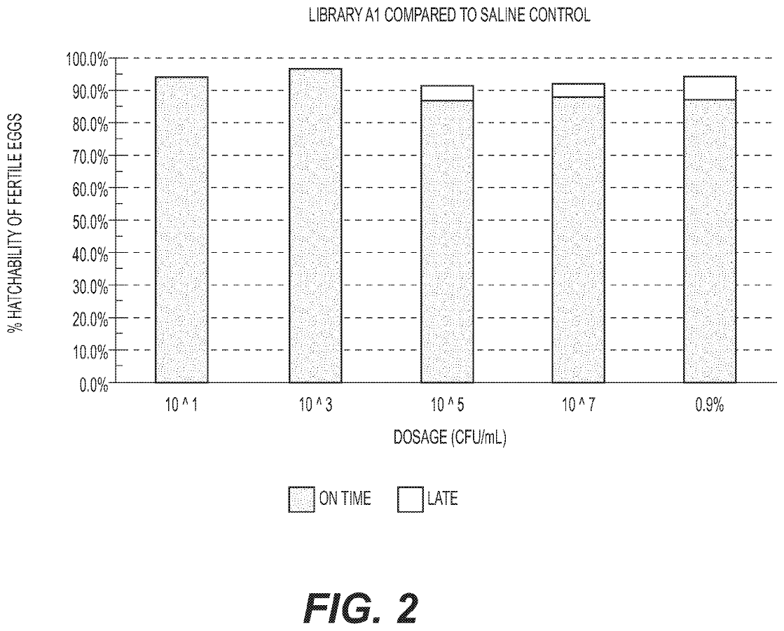

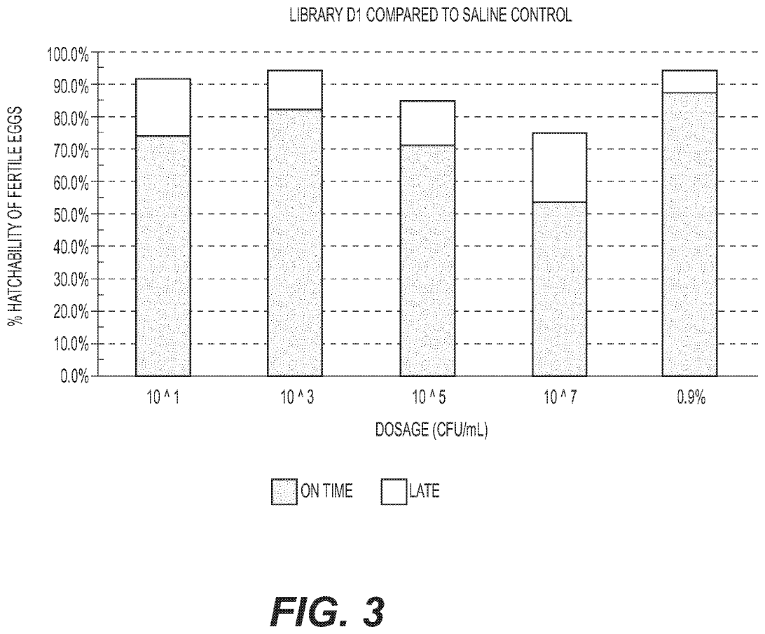

After the pipped eggs were counted, they were returned to the incubator for another 8 hours and counted again to see which pipped eggs fully hatched. FIGS. 2 and 3 and Table 4 summarize the results.

TABLE 4
Late hatching results.

| | | | | Total |
|---|---|---|---|---|
| | Dose | Pipped | | hatchability |
| | (CFU/ | eggs at | Hatched | with late |
| Treatment | mL) | hatching | late | hatchers |
| A1 | 10¹ | 1 | 0 | 94.0% |
| Library | 10³ | 1 | 0 | 96.4% |
| | 10⁵ | 6 | 4 | 92.3% |
| | 10⁷ | 3 | 3 | 92.2% |
| D1 | 10¹ | 16 | 15 | 91.7% |
| Library | 10³ | 11 | 10 | 94.1% |
| | 10⁵ | 21 | 11 | 84.8% |
| | 10⁷ | 22 | 17 | 74.4% |
| Saline | 0.9% | 8 | 7 | 97.7% |
| | 0.9% | 7 | 5 | 91.0% |

Surprisingly, IOF with Library Al improved hatchability at all dosage levels compared to the saline control, while IOF with Library D1 decreased with increasing dosages. For the D1 Library, even 10¹ and 10³ CFU/mL dosages had lower hatchability compared to the control. Another surprising outcome is a decreased time for full hatchability. When the pipped eggs from the saline and D1 IOFs were incubated for another 8 hours, hatchability increased to similar levels as the Al IOFs (>90%), except for the higher D1 dosages. The 10¹ and 10³ dosages of the Al Library needed no additional incubation time to reach full hatchability. Thus, IOF of Al Library at either 10¹ or 10³ CFU/mL both improved the hatchability of the eggs and had full hatchability at 21 days without the need for additional incubation. This could have a substantial impact on commercial hatcheries as spots in the hatcher can be turned over more quickly.

1. A method of treating an animal comprising administering to said animal an effective dose of a composition comprising at least one organism selected from the group consisting of the strains within the order Clostridiales, thereby improving said animal's health.

2. The method of claim 1, wherein said at least one organism comprise a genus selected from the group consisting of Acetobacterium, Acetoanaerobium, Blautia, Butyribacterium, Clostridium, Eubacterium, Hungateiclostridium, Lachnoclostridium, Moorella, Oxobacter, Paraclostridium, Peptoclostridium, Pseudoclostridium, Ruminiclostridium, Sporomusa, Terrisporobacter, Thermoanaerobacter, Thermoanaerobacterium, and Thermoclostridium.

3. The method of claim 1, wherein said at least one organism comprises at least one of Eubacterium aggregans, acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubacterium aggregans, Eubacterium limosum, Paraclostridium bifermentans, Oxobacter pfennigii, Sporomusa termitida, and Terrisporobacter glycolicus.

4. The method of claim 1, wherein said animal is selected from the group consisting of human, pigs, cows, fish, shrimps, horses, mammals, fishes, crustacean, avians and reptiles.

5. The method of claim 1, wherein said animal is selected from the group consisting of broilers, hens, turkeys, ducks, and fowls.

6. The method of claim 1, wherein said improving health comprises colonizing said animal's digestive track with said organism.

7.-8. (canceled)

9. The method of claim 1, wherein said composition comprises cells of said organism at a concentration of at least 10¹ Colony-Forming Units per milliliter.

10.-11. (canceled)

12. The method of claim 1, wherein said improving health comprises at least one of regulating the immune system, improving digestion, inhibiting the growth of pathogenic bacteria, forming butyric acid, reducing or preventing respiratory problems, reducing or preventing Coccidia infection, utilizing lactic acid, reducing or preventing dysbiosis, improving feed utilization, improving feed conversion, reducing or eliminating antibiotic use, decreasing mortality and reducing deformities.

13.-14. (canceled)

15. The method of claim 1, wherein said administering comprises in ovo application.

16. The method of claim 15, wherein said in ovo application improves hatchability rate of eggs and reducing the time until hatching

17.-20. (canceled)

21. The method of claim 1, wherein said composition further comprises cells of at least one Bacillus amyloliquefaciens; Bacillus toyonensis; Bacillus coagulans; Bacillus licheniformis; Bacillus megaterium; Bacillus mesentricus; Bacillus polymyxa; Bacillus subtilis; Bifidobacterium animalis; Bifidobacterium bifidium; Bifidobacterium bifidus; Bifidobacterium thermophilus; Bifidobacterium longum; Bifidobacterium pseudolongum; Bifidobacterium lactis; Clostridium butyricum; Enterococcus faecium; Enterococcus faecalis; Eschericia coli; Lactobacillus thermophilus; Lactobacillus acidophilus; Lactobacillus brevis; Lactobacillus bulgaricus; Lactobacillus casei; Lactobacillus delbrueckii; Lactobacillus subspecies; Lactobacillus bulgaricus; Lactobacillus farciminis; Lactobacillus fermentum; Lactobacillus gallinarum; Lactobacillus jensenii; Lactobacillus paracasei; Lactobacillus plantarum; Lactobacillus reuteri; Lactobacillus rhamnosus; Lactobacillus lactis; Lactobacillus salivarius; Lactobacillus sobrius; Megasphaera elsdenii; Pediococcus acidolactici; Propionibacterium shermanii; Propionibacterium freudenreichii; Propionibacterium acidipropionici; Propionibacterium jensenii; Saccharomyces bourlrdii; Saccharomyces cerevisiae; Saccharomyces servisia; Streptococcus faecalis; Streptococcus faecium; Streptococcus gallolyticus; Streptococcus salivarius; Streptococcus subsp.; Streptococcus thermophilus; and Streptococcus bovis.

22.-29. (canceled)

30. The method of claim 1, wherein the composition comprises a mixture of organisms and said mixture of organisms comprises at least one lactate forming organism and at least one lactate-utilizing organism.

31. (canceled)

32. A composition for a probiotic application, comprising at least one organism selected from the group consisting of the organisms within the order Clostridiales, and a carrier.

33. The composition of claim 32, wherein said carrier maintains an anaerobic environment for said organism.

34.-40. (canceled)

41. A method of treating an avian comprising administering in ovo an effective dose of a composition comprising an organism selected from the group consisting of the organisms within the order Clostridiales, thereby improving its health.

42. The method of claim 41, wherein said organism is characterized by at least one of butanoate metabolism, obligate anaerobic growth, gas fixation via the reductive acetyl-coenzyme A pathway, tolerance to bile salts at concentration greater than 0.05%, tolerance to pH of less than 3.5, and self-aggregation.

43.-44. (canceled)

45. The method of claim 41 wherein said organism comprise a genus selected from the group consisting of Acetobacterium, Acetoanaerobium, Blautia, Butyribacterium, Clostridium, Desulfitobacterium, Desulgotomaculum, Eubacterium, Hungateiclostridium, Lachnoclostridium, Moorella, Oxobacter, Paraclostridium Peptoclostridium, Pseudoclostridium, Ruminiclostridium, Sporomua, Terrisporobacter, Thermoanaerobacter, Thermoanaerobacterium, or Thermoclostridium.

46. The method of claim 41 wherein said organism comprises at least one of Acetobacterium woodii, Blautia producta, Butyribacterium methylotrophicum, Clostridium acetobutylicum, Clostridium autoethanogenum, Clostridium beijerinckii, Clostridium butyricum, Clostridium carboxidivorans, Clostridium drakei, Clostridium ljungdahlii, Clostridium kluyveri, Clostridium pasteurianum, Clostridium saccharobutylicum, Clostridium saccharoperbutylacetonicum, Clostridium scatologenes, Clostridium tyrobutyricum, Eubacterium aggregans, Eubacterium limosum, Paraclostridium bifermentans, Oxobacter pfennigii, Sporomusa termitida, or Terrisporobacter glycolicus.

47.-56. (canceled)

57. The method of claim 41, wherein said composition further comprises cells of at least one Bacillus amyloliquefaciens; BacillusBacillus toyonensis; BacillusBacillus coagulans; BacillusBacillus licheniformis; Bacillus megaterium; Bacillus mesentricus; Bacillus polymyxa; Bacillus subtilis; Bifidobacterium animalis; Bifidobacterium bifidium; Bifidobacterium bifidus; Bifidobacterium thermophilus; Bifidobacterium longum; Bifidobacterium pseudolongum; Bifidobacterium lactis; Clostridium butyricum; Enterococcus faecium; Enterococcus faecalis; Eschericia coli; Lactobacillus thermophilus; Lactobacillus acidophilus; Lactobacillus brevis; Lactobacillus bulgaricus; Lactobacillus casei; Lactobacillus delbrueckii; Lactobacillus subspecies; Lactobacillus bulgaricus; Lactobacillus farciminis; Lactobacillus fermentum; Lactobacillus gallinarum; Lactobacillus jensenii; Lactobacillus paracasei; Lactobacillus plantarum; Lactobacillus reuteri; Lactobacillus rhamnosus; Lactobacillus lactis; Lactobacillus salivarius; Lactobacillus sobrius; Megasphaera elsdenii; Pediococcus acidolactici; Propionibacterium shermanii; Propionibacterium freudenreichii; Propionibacterium acidipropionici; Propionibacterium jensenii; Saccharomyces bourlrdii; Saccharomyces cerevisiae; Saccharomyces servisia; Streptococcus faecalis; Streptococcus faecium; Streptococcus gallolyticus; Streptococcus salivarius; Streptococcus subsp.; Streptococcus thermophilus; and Streptococcus bovis.

58.-61. (canceled)

62. The method of claim 41, wherein the composition comprises an acetogen.

63.-68. (canceled)
